(19) United States
(12) Patent Application Publication
(10) Pub. No.: US 2019/0071024 A1
(43) Pub. Date: Mar. 7, 2019

(54) DEVICE FOR FASTENING A LOAD CARRIER TO A TRAILER HITCH OF A MOTOR VEHICLE AND A LOAD CARRIER

(71) Applicant: UEBLER GMBH, Forchheim (DE)

(72) Inventor: Klaus UEBLER, Erlangen (DE)

(21) Appl. No.: 15/824,134

(22) Filed: Nov. 28, 2017

(30) Foreign Application Priority Data
Sep. 4, 2017 (DE) 10 2017 120 287.0

(51) Int. Cl. B60R 9/06; B60R 9/10

(52) U.S. Cl. CPC B60R 9/06; B60R 9/10

(57) ABSTRACT

The invention relates to a device (1) for fastening a load carrier (2) to a motor vehicle trailer hitch (3) having a rectangular tube, this device comprising:
a first fastening section (A) for fastening the load carrier (2) and a second fastening section (B) extending from it for fastening to the trailer hitch (3);
the second fastening section (B) having two first plates (6) running parallel to one another and being solidly connected with the first fastening section (A), between which a second plate (7) is movably held; and
the second plate (7) being held floating near a free first end (E1), and a tensioning device (10) being provided at a second end (E2) opposite the first end (E1) for mutual bracing of the first (6) and the second plates (7) in the rectangular tube of the trailer hitch (3).

The invention relates to a device for fastening a load carrier to a trailer hitch of a motor vehicle, in particular of a motor vehicle equipped with a trailer hitch according to the U.S.A. standard.

Especially on the U.S.A. market, trailer hitches of motor vehicles are made essentially from a rectangular tube that has openings that are opposite one another. To fasten a load carrier, a fastening section of the load carrier is inserted into the rectangular tube and secured by means of a bolt. Such fastening sections of load carriers can also have a tensioning device with which the fastening section can be braced in the rectangular tube. Concerning this, reference is made to the following prior art documents: U.S. Pat. Nos. 5,423,566, 5,333,888, 5,615,904, US 2006/0208456 A1, U.S. Pat. Nos. 6,974,147 B1 and 8,141,760 B2.

The tensioning devices known from the prior art either have a complicated structure, or do not allow the fastening section to be braced with the trailer hitch so that there is no clearance.

An object of the invention is to eliminate the disadvantages of the prior art. In particular, the object is to indicate a device for fastening a load carrier to a trailer hitch of a motor vehicle, this device being as simple and as economically built as possible. Another object of the invention is for the device to allow the load carrier to be braced with the trailer hitch so that there is essentially no clearance. Finally, an object is to indicate a correspondingly improved load carrier.

This is accomplished by the features of claims 1 and 13. Expedient embodiments of the invention follow from the features of the dependent claims.

According to the invention, a device is proposed for fastening a load carrier to a motor vehicle trailer hitch having a rectangular tube, this device comprising:

a first fastening section for fastening the load carrier and a second fastening section extending from it for fastening to the trailer hitch;
the second fastening section having two first plates running parallel to one another and being solidly connected with the first fastening section, between which a second plate is movably held; and
the second plate being held floating near a free first end, and a tensioning device being provided at a second end opposite the first end for mutual bracing of the first and the second plates in the rectangular tube of the trailer hitch.

The device proposed according to the invention is a universal mount for attaching different load carriers to a trailer hitch of a motor vehicle. It has a first fastening section for attaching the load carrier and a second fastening section extending from it. The second fastening section is designed so that it can be inserted into the trailer hitch and braced so that there is essentially no clearance. To accomplish this, the second fastening section has two first plates running parallel to one another and solidly connected with the first fastening section. The first plates have a second plate movably held between them. The second plate is held floating at a free end between the first plates, i.e., the second plate can move a specified distance both in the horizontal and in the vertical directions relative to the first plates in the area of the first end.

The tensioning device can adjust the second plate relative to the first plates. If the second fastening section is inserted into the rectangular tube, the tensioning device can brace the second plate relative to the first plate and the inner wall of the rectangular tube so that the device is fastened in the trailer hitch so that there is essentially no clearance. In particular, the proposed device makes it possible to compensate for manufacturing tolerances regarding the inner geometry of the rectangular tube of the trailer hitch.

It is expedient for the second plate to be held between the first plates in such a way that first openings that are opposite one another in the first plates and a second opening provided in the second plate can be lined up to pass through a bolt. Furthermore, the first and the second openings are expediently shaped so that they correspond with other openings that are usually provided in the rectangular tube of trailer hitches, to pass through the security bolt.

In one advantageous embodiment, a first distance between the free end of the second plate and a center of the second opening is smaller than a second distance between the center and the tensioning device provided at the other end of the second plate. The fact that the first distance is less than the second distance allows an especially large bracing force to be applied because of leverage from the tensioning device.

The proposed device is simple and economically built. It allows a high tensioning force to be applied. The device according to the invention allows load carriers to be braced in trailer hitches according to the U.S. standard so that there is essentially no clearance. Mounting the device according to the invention does not require any tools. The mounting can be carried out quickly and simply.

According to one advantageous embodiment of the invention, the second plate has a third opening through which further bolt is passed, this further bolt extending between the first plates. The third opening is expediently provided between a free end of the second plate and the second opening. The further bolt that is passed through the third opening serves, together with the tensioning device, to hold the second plate between the first plates. The further bolt is expediently held in fourth openings arranged opposite one another on the first plates. This simplifies the mounting of the further bolt.

According to another advantageous embodiment, a first diameter of the first openings is smaller than a second diameter of the second opening and a third diameter of the third opening is larger than a fourth diameter of the fourth opening. The first diameter is essentially selected in such a way that the bolt can be passed through the first opening with little clearance. The second diameter is larger than the first diameter. The fourth diameter of the fourth openings essentially corresponds to the diameter of the further bolt. The further bolt is solidly held in the fourth openings. By contrast, the third diameter of the third opening is larger than the fourth diameter of the fourth openings. Because the second and the third openings are made larger, the second plate is held so that it is floating, so to speak, between the first plates. This makes it possible to compensate for the relatively large tolerances in trailer hitches according to the U.S.A. standard, and simultaneously ensures bracing that is essentially free of clearance.

According to another embodiment of the invention, the tensioning device has a tube section at the other end of the second plate and a bridge connecting the first plates, this bridge having a fifth opening, a tensioning bolt being passed through the tube section and the fifth opening to force the tube section in the direction of the bridge. When the second fastening section is pushed into the trailer hitch, the tensioning device makes it possible to move the second plate relative to the first plates and thus to brace the second fastening section in the trailer hitch.

It is expedient for the tensioning bolt to be a component of a quick clamping device. This makes it quick and simple to brace the second fastening section with a trailer hitch.

According to another embodiment, the first fastening section is made of two opposite third plates in a single piece with the first plates, these third plates being connected together with the interposition of spacers. The third plates can be made from a single piece with the first plates. It is also possible for the third plates to be welded, for example, with the first plates. Instead of the first fastening section made of the third plates, it is also possible for a fastening section made in a different way to be solidly connected with the second fastening section.

It is possible for the third plates to have opposite sixth openings to pass through fastening bolts to fasten the load carrier. This allows fastening of load carriers of different design.

A height and a width of the second fastening section formed by the first plates are preferably in the range of 30 mm to 35 mm or in the range of 49 mm to 54 mm. The proposed dimensions allow the second fastening section to be inserted into the rectangular tube of a common trailer hitch. This allows secure and reliable bracing of the second fastening section in the trailer hitch.

According to another advantageous embodiment, a lock is provided to secure the bolt in the mounted state. The lock serves as an antitheft device.

A sample embodiment of the invention is explained in detail below using the drawings. The figures are as follows:

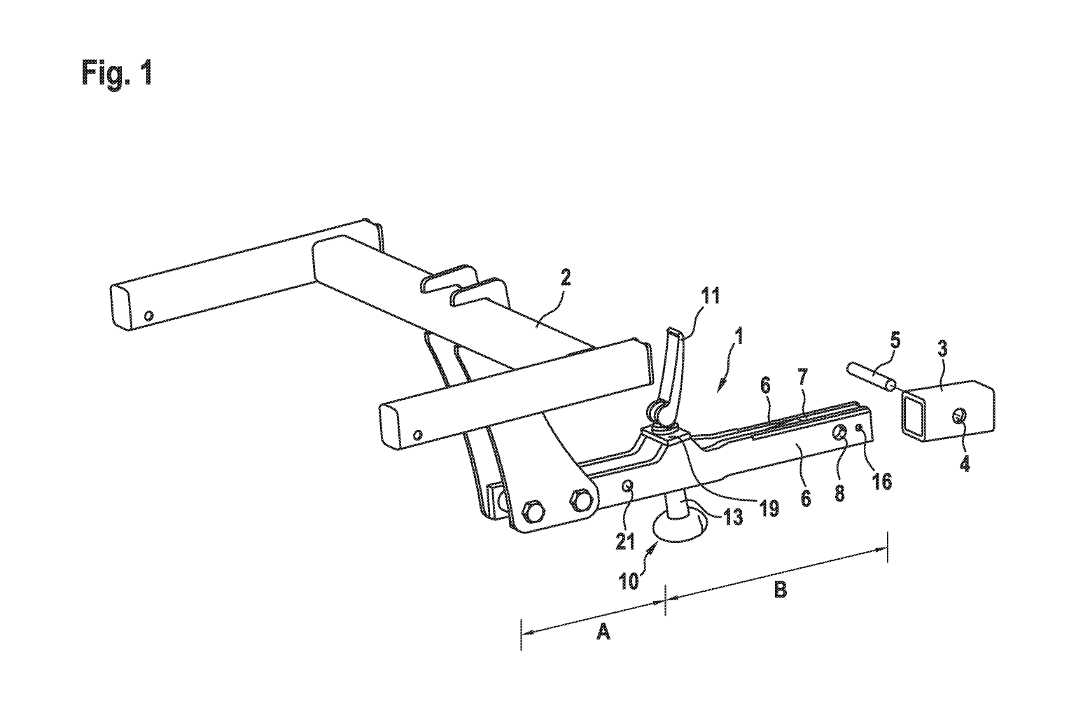

FIG. 1 A first perspective view of a device to which is fastened a holder for a load carrier;

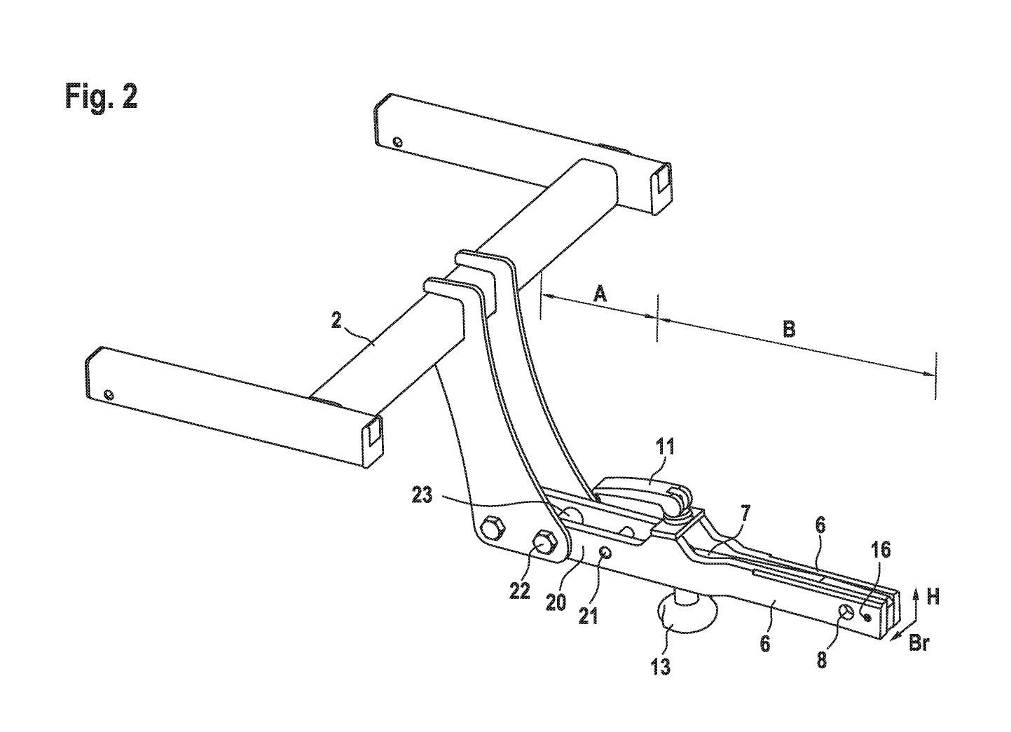

FIG. 2 A second perspective view according to FIG. 1;

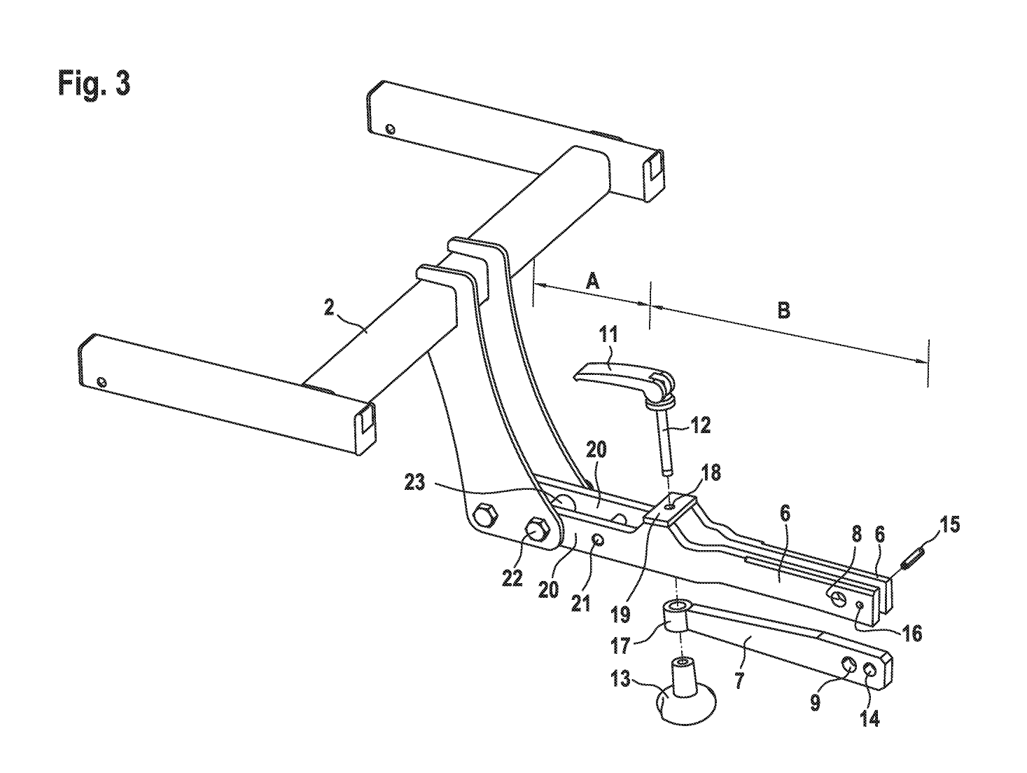

FIG. 3 An exploded view according to FIG. 2;

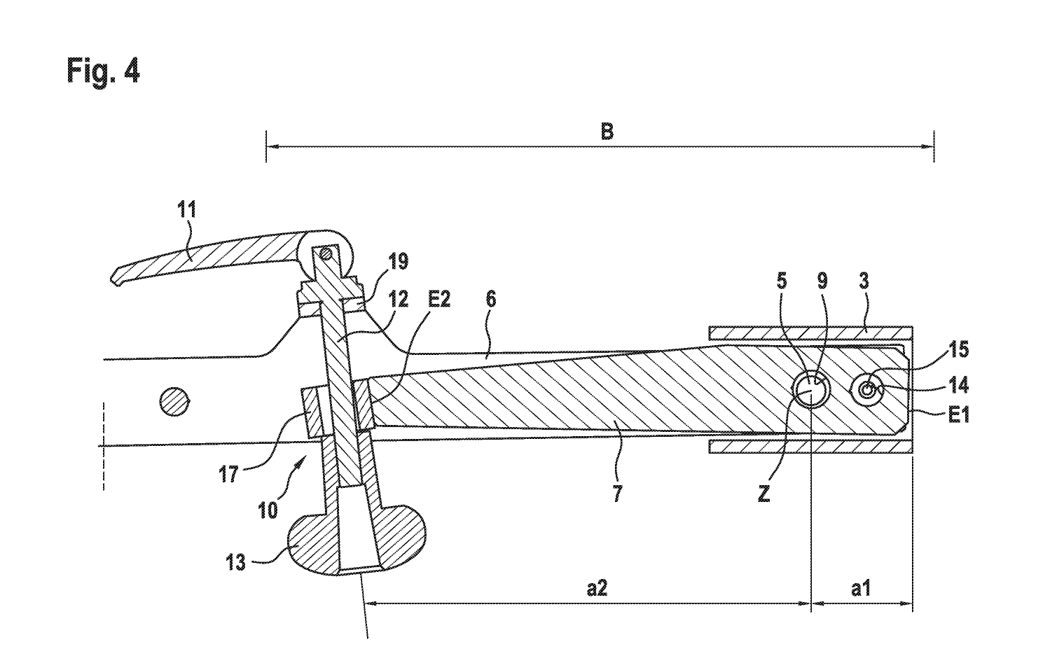

FIG. 4 A sectional view through the second plate, the second fastening section being pushed into the trailer hitch; and

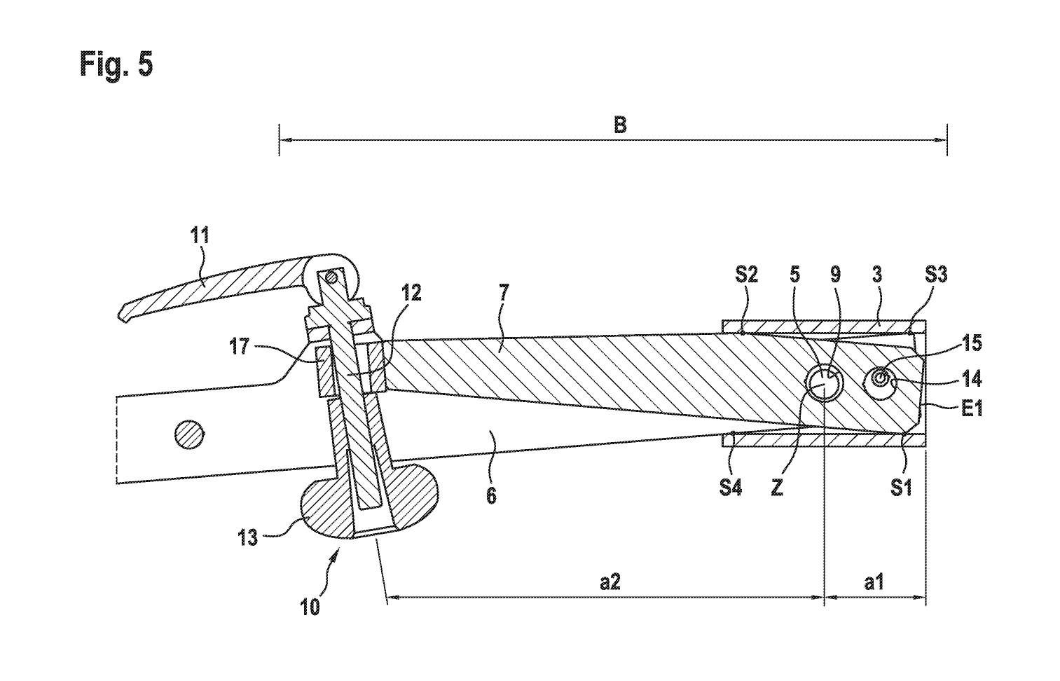

FIG. 5 Another view according to FIG. 4, wherein the second fastening section is braced in the trailer hitch.

FIG. 1 shows a device for fastening a load carrier that is generally designated with the reference number 1. Here only a holder 2 is shown, which is a component of the load carrier. The device comprises a first fastening section A for fastening the load carrier or its holder 2, respectively, and a second fastening section B for fastening to a trailer hitch 3. The trailer hitch 3 is essentially made from a rectangular tube that has opposite tube openings 4 to pass through a bolt 5.

The second fastening section B has two first plates 6 running parallel to one another, between which a second plate 7 is movably held. As is especially clear when FIG. 3 through 5 are viewed together, the first plates 6 have first openings 8, which can be lined up with a second opening 9 to pass through the bolt 5. A first distance a1 between a free first end E1 of the second plate 7 and a center Z of the second opening 5 is smaller than a second distance a2 between the center Z and a tensioning device 10 provided at a second end E2 of the second plate 7. The first end E1 lies opposite the second end E2 in the direction in which the second plate 7 extends.

Here the tensioning device 10 is in the form of a quick clamping device. It comprises a tensioning bolt 12 that is pivotably connected with a cam lever 11 and also comprises a threaded knob 13.

The second plate 7 has a third opening 14, through which a further bolt 15 is passed. The further bolt 15 is preferably a roll pin that is held in fourth openings 16. The fourth openings 16 are arranged opposite one another in the first plates 6.

A first diameter of the first openings 8 is smaller than a second diameter of the second opening 9. The first diameter of the first openings 8 approximately corresponds to the diameter of the bolt 5.

A third diameter of the third opening 14 is larger than a fourth diameter of the fourth openings 16.

The tensioning bolt 12 of the tensioning device 10 reaches through a tube section 17 at the second end E2 of the second plate 7 and a fifth opening 18, which is provided in a bridge 19 connecting the first plates 6. The reference number 20 designates third plates that are made in a single piece with the first plates 6. The third plates 20 have sixth openings 21 in them to pass through fastening bolts 22.

The third plates 20 are held separated from one another by means of spacers 23.

The device operates as follows:

To fasten the second fastening section B in a trailer hitch 3, the second fastening section B is inserted into the trailer hitch 3. The height H and width Br (see FIG. 2) of the second fastening section B are dimensioned so that the first plates 6 and the second plate 7 can be inserted into the trailer hitch 3 until the first openings 8 are aligned with the tube openings 4 of the trailer hitch 3. As soon as this is the case, the bolt 5 is pushed through the tube openings 4 of the trailer hitch 3 and through the first 8 and the second openings 9, and is secured by securing means (not shown here).

FIG. 4 shows a longitudinal section through the second plate 7 in the state in which it is inserted into the trailer hitch 3. The tensioning device 10 is released. To brace the second fastening section B, the cam lever 11 is put into a vertical position, which approximately corresponds to the extension of the axis of the tensioning bolt 12. Rotating the threaded knob 13 forces the second end E2 of the second plate 7 in the direction of the bridge 19, which is solidly connected with the first plates 6. To increase the tensions acting on the first plates 6 and the second plate 7, the cam lever 11 is then pressed into the essentially horizontal position shown in FIG. 5. When the tensioning device is tensioned, a first section S1 at the first end E1 of the second plate 7 and a second section S2, which is located approximately diagonally opposite the first section S1 with respect to the center Z, are each forced against the inner wall of the trailer hitch 3. Simultaneously, third sections S3 of the first plates 6 that are located in the area of the first end E1 and fourth sections S4 of the second plate 7 that are approximately diagonally opposite with respect to the center Z, are each forced against the inner wall of the trailer hitch 3. The first section S1 and the second section S2 lie on a first diagonal, and the third section S3 and the fourth section S4 lie on a second diagonal. The first and the second diagonals are different from one another. They cross approximately in the area of the second opening 9. The crosswise bracing of the first plates 6 and the second plate 7 fastens the second fastening section B in the trailer hitch 3 in a way that is especially solid and free of clearance.

In particular, the floating support of the second plate 7 with respect to the first plates 6 also allows the proposed device to compensate for possible manufacturing tolerances with respect to an inner geometry of the trailer hitch 3. The proposed device is robust and simple to operate. It is built from few parts and is economical.

The tensioning device described above pulls the second plate 7 against the bridge 15. Of course, it is also possible for the tensioning device to have a different design. It is also conceivable to brace the first plates 6 and the second plate 7 using a tightening screw, i.e., to omit the cam lever. It is also possible to apply a compressive stress instead of a tensile stress to brace the first plates 6 and the second plate 7.

### LIST OF REFERENCE NUMBERS

1 Device
2 Holder
3 Trailer hitch
4 Tube opening
5 Bolt
6 First plate
7 Second plate
8 First opening
9 Second opening
10 Tensioning device
11 Cam lever
12 Tensioning bolt
13 Threaded knob
14 Third opening
15 Further bolt
16 Fourth opening
17 Tube section
18 Fifth opening
19 Bridge
20 Third plate
21 Sixth opening
22 Fastening bolt
23 Spacer
A First fastening section
a1 First distance
a2 Second distance
B Second fastening section
Br Width
E1 First end
E2 Second end
H Height
First section
S2 Second section
S3 Third section
S4 Fourth section
Z Center

1. A device (1) for fastening a load carrier (2) to a motor vehicle trailer hitch (3) having a rectangular tube, this device comprising:
a first fastening section (A) for fastening the load carrier (2) and a second fastening section (B) extending from it for fastening to the trailer hitch (3);
the second fastening section (B) having two first plates (6) running parallel to one another and being solidly connected with the first fastening section (A), between which a second plate (7) is movably held; and
the second plate (7) being held floating near a free first end (E1), and a tensioning device (10) being provided at a second end (E2) opposite the first end (E1) for mutual bracing of the first (6) and the second plates (7) in the rectangular tube of the trailer hitch (3).

2. A device according to claim 1, wherein the second plate (7) is held between the first plates (6) in such a way that first openings (8) that are opposite one another in the first plates (6) and a second opening (9) provided in the second plate (7) can be lined up to pass through a bolt (5).

3. A device according to claim 1, wherein a first distance (a1) between a free first end (E1) of the second plate (7) and a center (Z) of the second opening (9) is smaller than a second distance (a2) between the center (Z) and the tensioning device (10) provided at the second end (E2) of the second plate (7).

4. A device according to claim 1, wherein the second plate (7) has a third opening (14) through which is passed another bolt (15) extending between the first plates (6).

5. A device according to claim 1, wherein the other bolt (15) is held in fourth openings (16) arranged opposite one another on the first plates (6).

6. A device according to claim 1, wherein a first diameter of the first openings (8) is smaller than a second diameter of the second opening (9), and a third diameter of the third opening (14) is larger than a fourth diameter of the fourth openings (16).

7. A device according to claim 1, wherein the tensioning device (10) has a tube section (17) at the other end (E2) of the second plate (7) and a bridge (19) connecting the first plates (6), this bridge having a fifth opening (18), a tensioning bolt (12) being passed through the tube section (17) and the fifth opening (18) to force the tube section (17) in the direction of the bridge (19).

8. A device according to claim 1, wherein the tensioning bolt (12) is a component of a quick clamping device.

9. A device according to claim 1, wherein the first fastening section (A) is made of two opposite third plates (20) in a single piece with the first plates (6), these third plates being connected together with the interposition of spacers (23).

10. A device according to claim 1, wherein the third plates (20) have opposite sixth openings (21) to pass through fastening bolts (22) to fasten the load carrier (2).

11. A device according to claim 1, wherein a height (H) and a width (Br) of the second fastening section (B), this height (H) and width (Br) being formed by the first plates (6), are in the range of 30 mm to 35 mm or in the range of 49 mm to 54 mm.

12. A device according to claim 1, wherein a lock is provided for securing the bolt (5) in the mounted state.

13. A load carrier (2), in particular for holding bicycles, with a device according to claim 1.
